(19) United States
(12) Patent Application Publication
(10) Pub. No.: US 2011/0131864 A1
(43) Pub. Date: Jun. 9, 2011

(54) Fishing lure

(76) Inventor: Fabien J. Provost, Broussard, LA (US)

(21) Appl. No.: 12/592,830

(22) Filed: Dec. 3, 2009

(51) Int. Cl. A01K 85/00; A01K 85/02

(52) U.S. Cl. 43/42.24; 43/42.36; 43/42.41

(57) ABSTRACT

A fishing lure made from a pliable flexible material is designed to simulate movements of live bait when pulled through water. The middle portion of the lure body is formed with a width substantially greater than a head portion or the tail portion. The width of the tail portion is substantially smaller than the middle portion and the head portion, while the length of the tail portion is equal to or slightly smaller than a combined length of the middle portion and the head portion.

### BACKGROUND OF THE INVENTION

This invention relates to fishing lures and more particularly, to soft plastic fishing lures having tail portions that simulate a swimming action of live bait as the lure is retrieved through a water body.

Fishermen have for centuries attempted to design the perfect bait to lure their intended catch to their hook. Fishermen know that fish are instinctively attracted to the movement of live bait. However, it is not always possible or convenient for a fisherman to carry or fish with live bait. Further, live bait is more expensive to use, is not always readily available, and is difficult to place on a barbed hook without killing the bait or otherwise greatly reducing its ability or desire to move naturally. A large variety of lures have been designed and manufactured to assist the catching of fish, such as bass, bluefish and tuna. These lures are made in a variety of shapes, sizes, colors, textures and weights and are made from a whole range of materials, from metals, to plastics and to soft plastics and rubbers. While manufacturers of such lures have succeeded in designing artificial bait with a generally life-like appearance, they have not been completely successful at designing a lure which simulates the movements of live bait in actual use.

It is desirable, when designing a lure to mimic bait (living or dead) in shape, size, smell, sound, appearance and action. The closer the action and appearance of the lure to the actual bait it is imitating, the more effective lure will generally be at catching fish. Sight and appearance play an important role, if not the most important role, in fish feeding habits, and fishermen are constantly seeking better and ever more effective lures.

The instant invention contemplates provision of an artificial fishing lure that simulates motions of live bait in the water by erratic movements of the lure body.

### SUMMARY OF THE INVENTION

It is, therefore, an object of the present invention to provide a fishing lure which simulates the appearance of a bait fish.

It is another object of the invention to provide a fishing lure which simulates the movement of a bait fish when pulled through water.

These and other objects of the invention are achieved through a provision of a fishing lure made from a pliable flexible material is designed to simulate movements of live bait when pulled through water. The middle portion of the lure body is formed with a width substantially greater than a head portion or the tail portion. The width of the tail portion is substantially smaller than the middle portion and the head portion, while the length of the tail portion is equal to or slightly smaller than a combined length of the middle portion and the head portion. In one aspect, the lure body has a density less than the density of water.

### BRIEF DESCRIPTION OF THE DRAWINGS

Reference will now be made to the drawings, wherein like parts are designated by like numerals, and wherein

FIG. 1 is a side view of the fishing lure according to the present invention.

FIG. 2 is a top view of the lure in a stationary position.

FIG. 3 illustrates movements of the lure as it is being pulled by a fishing line.

FIG. 4 is a side view of the lure in water.

FIG. 5 illustrates motions of the lure as it is being dragged underwater.

### DETAIL DESCRIPTION OF THE INVENTION

Turning now to the drawings in more detail, numeral 10 designates the fishing lure according to one of the embodiments of the invention. The lure 10 comprises a lure body having a head portion 12, a middle portion 14 unitary connected to the head portion 12, and a tail portion 16, unitary connected to the middle portion 14. The tail portion 16 has a tip 18 that has a generally spear-shaped configuration. The top surface 15 of the lure 10 is generally flat, while the bottom surface of the lure body has both rounded and outwardly convex portions.

The head portion provides an attachment end 20 for securing the lure 10 to a fishing line, as will be described in detail below. The top surface 17 of the head portion 12 has a rounded aspect, with the cross section of the head portion having a generally semi-circular configuration. The middle portion 14 has an outwardly convex bottom surface 22 and an increased width in comparison with the head portion 12. The bottom surface 22 of the middle portion 14 can be defined by a unitary formed section of the lure 10 or, alternatively, by a mid-section member that is fixedly attached, such as by glue, along the phantom line 25 to the middle portion 14. In any case, the width of the middle portion 14 is greater than the width of the head portion 12 and is substantially greater than the width of the tail portion 16. In one aspect, the head portion had twice the width of the portion, and the middle portion had about three times the width of the tail portion. The middle portion 14 defines a maximum width of the lure body.

The tail portion 16 has a rounded bottom surface 19 along substantially its entire length with the exception of the tip 18, which can be formed by two planar surfaces. In cross section, the tail section 16 may also have a semi-circular configuration. Of course, depending on the manufacturer's preference, the head portion 12 and the tail portion 16 may be formed cylindrical.

In one aspect, the length of the tail portion 16 is equal to the combined length of the head portion 12 and the middle portion 14. For instance, if the total length of the lure is 7 inches, then the tail 16, with the tip 18 can be approximately 3.5 inches long. If the total length of the lure is 4.5 inches the length of the tail portion 16 with the tip 18 can be almost 2.25 inches. In one of the preferred embodiments, where the lure body has a pre-determined length, the tail portion occupies at least one-half of the length of the lure body.

In one aspect, the lure 10 is formed from a soft flexible pliable resilient material that can be molded or injection molded. The density of the material is selected to be in value slightly less than the density of water that is less than 1 g/cm³

The density of the material depends on whether the manufacturer wishes the lure 10 to be fully submersible or buoyant. In one of the preferred embodiments, the density of the material that is used to form the lure 10 is only slightly less than the density of water so as to make the lure 10 particularly suitable for use in angler fishing.

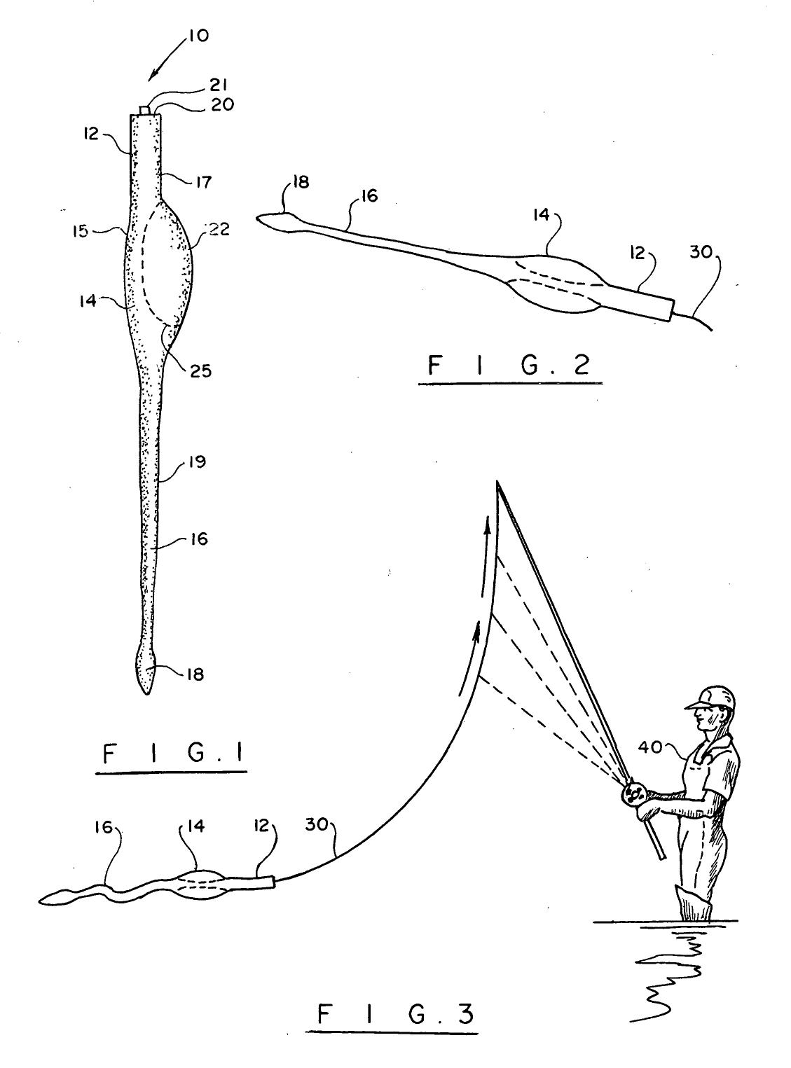

When the lure 10 is stationary, such as shown in FIGS. 1 and 2, the tail portion 16 is relatively straight, extending along a common central axis of the lure 10. A flexible fishing line 30 is connected to a loop 21 secured on the end 20 of the head portion 12 when preparing the lure 10 for use. A hook 32 can be secured to the bottom surface 15 of the head portion 12, as shown in FIGS. 4 and 5.

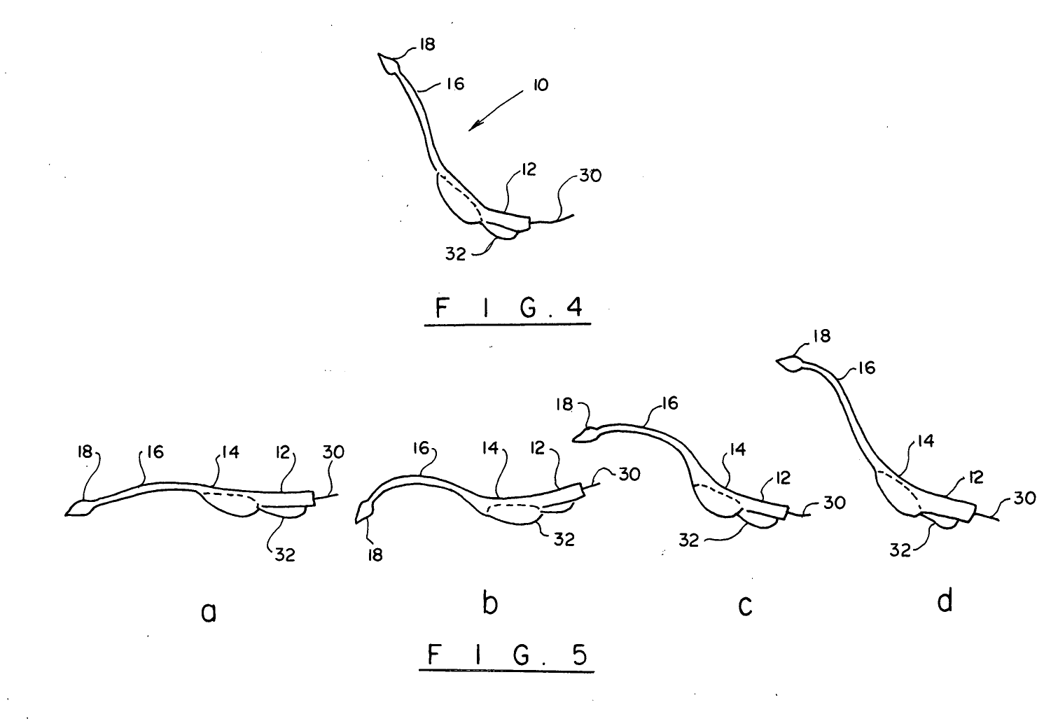

When an angler 40 (shown schematically in FIG. 3) pulls on the fishing line 30, with the lure 10 secured thereto, the tail portion 16 exhibits erratic motions, moving sideways, while the middle portion and the head portion moving along with the line pull. FIG. 3 illustrates this motion as a top view.

FIG. 5 illustrates a series of side views illustrating the motions of the lure that are designed to simulate the movements of live bait. FIG. 4 shows the lure 10 at rest when submerged in water. In this position, the tail portion 16, being lighter, extends upwardly, with the heavier head portion 12 and the middle portion 14 extending downwardly. As the angler begins to pull on the fishing line 30, the tail portion 16 moves downwardly and extending in general alignment to the middle portion 14 and the head portion 12, as shown in FIG. 5a.

As the pulling action on the fishing line 30 continues the tail portion 16 begins to arch upwardly, with the tip 18 facing down, as shown in FIG. 5b. Then the tail portion 16 moves further upwardly, enlarging the arc of movement, while positioning above the middle portion 14 and the head portion 12, as shown in FIG. 5c. When the pulling action on the fishing line 30 stops, the lure 10 returns to the “at rest” position shown in FIG. 5d.

The lure body of the instant invention can be decorated with paint, pattern, a line, an image, a design, imitation scales, glitter, foil, or a marking. The decorations of the lure may aid the lure body in appearing more fish-like or which simply may impart a tendency of the lure to better attract a particular type of fish, be it fresh water fish or a salt-water fish.

The lure body can be formed from a soft and/or pliable plastic or polymeric material through which a fishing hook can be inserted. Preferably, the plastics and/or polymeric materials used to construct the lure body are resilient, soft and flexible, for instance polystyrene, polyvinyl chloride, polyamide (or nylon), synthetic rubber, acrylic, polyethylene, polyfluorethylene, polypropylene, polyurethane, and the like or any combinations thereof.

The hook 32 may be secured on the body of the lure 10 in any suitable manner. For example, a hook can be inserted into the head portion 12 and exit the lure adjacent a line between the head portion 12 and the middle portion 14. The fishing line 30 may be attached to the end 20 by a hook, a loop or an eye-hook inserted into the end 20.

Many changes and modifications may be made in the present invention without departing from the spirit thereof. I, therefore, pray that my rights to the present invention be limited only by the scope of the appended claims.

I claim:

1. A fishing lure device, comprising:
a flexible resilient pliant lure body having a generally flat top surface, a rounded bottom surface, a head portion, a middle portion unitary connected to the head portion, and a tail portion unitary connected to the middle portion, wherein the middle portion is provided with an outwardly convex bottom surface, said middle portion defining a maximum width of the lure body.

2. The device of claim 1, wherein said lure body has a pre-determined length, and wherein the tail portion occupies about one-half of the length of the lure body.

3. The device of claim 1, wherein the lure body has a density less than 1 g/cm³

4. The device of claim 1, wherein the lure body is configured to simulate movements of live bait when the lure body is pulled through water.

5. The device of claim 1, wherein the head portion is configured to be secured to a fishing line.

6. The device of claim 1, wherein said tail portion is provided with a spear-shaped tip.

7. The device of claim 1, wherein each of said body portions has a discrete size, and wherein the tail portion has a length substantially equal to a combined length of the head portion and the middle portion.

8. The device of claim 1, wherein each of said body portions has a discreet width, and wherein the tail portion has a width substantially smaller than a width of the head portion and the middle portion.

9. A fishing lure device, comprising:
an elongated body having a head portion, a tail portion and a middle portion unitary connected to the head portion and the tail portion, each of said body portions having a discreet width and length, and wherein the length of the tail portion is equal to or slightly less than a combined length of the head portion and the middle portion.

10. The device if claim 9, wherein said lure body is formed from a resilient flexible pliant material having a density less than 1 g/cm³

11. The device of claim 9, wherein said lure body has a substantially flat top surface and variably convex bottom surface.

12. The device of claim 9, wherein said middle portion defines a maximum width of the lure body.

13. The device of claim 9, wherein the lure body is configured to simulate movements of live bait when the lure body is pulled through water.

14. The device of claim 9, wherein the head portion is configured to be secured to a fishing line.
